(19) United States
(12) Patent Application Publication
(10) Pub. No.: US 2026/0359329 A1
(43) Pub. Date: Nov. 12, 2026

(54) A FRAMEWORK FOR GENERATING RELEVANT QUERIES FOR AN ARTIFICIAL INTELLIGENCE MODEL

(71) Applicant: PayPal, Inc., San Jose, CA (US)

(72) Inventors: Guangsen WANG, Singapore (SG); Zehong MA, Shanghai (CN)

(21) Appl. No.: 18/870,383

(22) PCT Filed: Oct. 29, 2024
(86) PCT No.: PCT/CN2024/128144

§ 371 Date: Nov. 27, 2024

(51) Int. Cl. G06F 16/3329; G06F 16/3332; G06N 3/08

(52) U.S. Cl. CPC G06F 16/33295; G06F 16/3338; G06N 3/08

(57) ABSTRACT

Methods and systems are presented for providing a framework that provides information associated with a particular domain to an artificial intelligence (AI) model. The framework includes a query condenser model that reformulates user-generated queries, such that the reformulated query can be used to retrieve a set of documents that can be used by the AI model to generate a response to the user-generated query. The query condenser model is trained using outputs generated by a teacher model. When the reformulated query generated by the query condenser model does not satisfy a set of criteria, the teacher model is configured to generate an improved version of the reformulated query for retraining the query condenser model.

### BACKGROUND

The present specification generally relates to an artificial intelligence model framework, and more specifically, to providing a retrieval-augmented generation-based artificial intelligence model according to various embodiments of the disclosure.

### RELATED ART

Artificial intelligence (AI) models, such as large language models (LLMs), have been used by organizations to facilitate automated dialogue-based interactions with users. Typical LLMs, such as GPT-4, BERT, LLaMA, etc., are powerful and flexible as they are capable of learning and generating content (e.g., responses to user-queries) in a natural language format across a wide range of subject matters (also referred to as “domains”). However, while these generic AI models are trained to provide responses in a wide range of subject matters, they are not specialized in any particular subject matter. For example, a generic AI model may not be trained to provide information specifically associated with an organization (e.g., answering questions related to the organization, etc.). As such, the generic AI model may require assistance in generating responses for a particular domain. In this regard, a retrieval-augmented generation (RAG) framework can be used to retrieve additional information (e.g., internal documents of the organization, etc.) based on a user query, and provide the additional information to the AI model, such that the AI model can “learn” from the additional information and generate a more accurate or higher quality response for the user query using the content from the additional information.

Due to the usage of tools such as the RAG framework, the quality of the response from the AI model is largely dependent on the quality (e.g., volume, relevancy, etc.) of the additional information that is provided to the AI model. When the scope of the additional information is overly broad (e.g., the additional information includes a substantial amount of information that is irrelevant to the user query), overly narrow (e.g., the additional information lacks sufficient information that is relevant to the user query), or incorrect or not useful (e.g., the additional information is not relevant to the user query), the quality or accuracy of the response suffers. It has been a challenge for a RAG framework to retrieve documents within a proper scope, such that a sufficient amount of information that is relevant to the user query is retrieved, without including excessive irrelevant information. Thus, there is a need for an improved framework for performing data retrieval for AI models.

### BRIEF DESCRIPTION OF THE FIGURES

FIG. 1 is a block diagram illustrating an electronic transaction system according to an embodiment of the present disclosure;

FIG. 2 is a block diagram illustrating a chat module according to an embodiment of the present disclosure;

FIG. 3 is a block diagram illustrating a training module according to an embodiment of the present disclosure;

FIG. 4 is a flowchart showing a process of training a query condenser module according to an embodiment of the present disclosure;

FIG. 5 illustrates an example neural network that can be used to implement a machine learning model according to an embodiment of the present disclosure; and

FIG. 6 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a framework that provides information associated with a particular domain to an artificial intelligence (AI) model, which improves the capability of the AI model to generate a response to a user query. An AI model is a type of machine learning (ML) model in that it includes computer software structures (e.g., neurons that are connected in multiple layers, etc.) capable of learning patterns (e.g., self-modifications through one or more training processes). However, an AI model is typically substantially more complex than an ML model. For example, an AI model typically includes millions or even billions of parameters, as opposed to thousands of parameters typically found in an ML model. A parameter in an ML model is an internal variable that the ML model uses for generating one or more outputs. The parameter is automatically adjusted during the training phase based on the training data. As such, the modifications to the parameters enable the ML model to learn patterns and predict accuracy outputs based on the patterns. The increased complexity enables the AI model to be more flexible than the ML model, at a cost of increased consumption of computer processing resources and processing time. In some embodiments, an AI model is capable of accepting input values in any format, and is also capable of generating output values in any format. For example, an AI model can be configured to interpret any phrase, sentence, inquiry, etc. in a natural language format (or in any language format). The AI model can also be configured to generate outputs in any free-form natural language format (or language of any types, such as programming languages, application programming interface (API) calls to other computer modules, etc.). As such, an AI model can be used to facilitate communications with humans or other computer modules in their native languages/interfaces without requiring any customization to the AI model. Example AI models include deep machine learning models, large language models, small language models, etc.

As discussed herein, AI models are typically trained to provide generic information about a wide range of domains, but are not trained to provide responses that are specific to any particular domain (e.g., not trained to provide information related to specific processes, procedures, and policies associated with a particular organization, etc.). For example, when a user query is related to a question on how to perform a certain transaction with the organization (e.g., how to perform a dispute of a transaction through a website of the organization, etc.), it would not be very useful if the AI model provides a response that includes information on how to perform the transaction in an environment outside the organization (e.g., steps of performing the transaction with another organization, etc.).

In some embodiments, in order for an organization to use an AI model to provide information specific to a particular domain (e.g., specific to the organization, specific to a group of entities, etc.) to its users, an RAG framework can be used. An RAG framework may assist the AI model to generate responses specific to a particular domain by retrieving information related to the user query from a pre-defined corpus, and provide the information along with the user query to the AI model. For example, an organization may compile documents (e.g., white papers, webpages, articles, internal instructions, etc.) that are related to a particular domain (e.g., information associated with the organization, etc.) to form a corpus. Documents, as used herein, may be in any format (digital/electronic or non-digital/physical) that includes data, content, or information, which can have or not have size limits. In some embodiments, any documents that are not part of the domain are excluded from the corpus. As a chat system associated with the organization receives a user query from a device, instead of providing the user query directly to the AI model, the chat system may first use a retrieval module to retrieve information relevant to the user query from the corpus. The information, in addition to the user query, may be provided to the AI model. Since the corpus includes documents specific to the domain, using the information retrieved from the corpus by the retrieval module, the AI model may generate a response that is associated with the particular domain.

For example, when the user query includes a question about how to dispute a transaction through a website of the organization, the retrieval module may retrieve documents from the corpus that are specifically related to instructions in filing a dispute of a transaction on the organization's website. In another example, when the user query includes a question about how to reset a password, the retrieval module may retrieve documents from the corpus that are specifically related to resetting passwords. The chat system may then generate a prompt for the AI model based on the user query and the information (e.g., the documents, etc.) retrieved by the retrieval module. The AI model may then generate a response using the information provided by the retrieval module. Since the documents in the corpus include content specifically related to the organization, by using the information retrieved by the retrieval module in addition to the user query, the AI model is able to generate a response that is associated with the particular domain (e.g., information related to the organization). For example, by using the RAG framework, the AI model may generate a response that includes specific instructions on how to perform a transaction with the organization based on the relevant information from the corpus.

Since the AI model generates responses based on the information retrieved by the retrieval module, the quality of the response is largely dependent on the quality of the information (e.g., the amount of information included in the additional information, the relevancy of the additional information to the user query, the type of information of the additional information, etc.) and therefore, the performance of the retrieval module. As defined herein, information is relevant to the query when the information includes content that is associated with the query (e.g., information that is usable to answer the query, etc.), content that is requested by the user, or that is usable by the AI model to generate a response that provides an accurate answer requested by the user. Information is irrelevant to the query when the information is not associated with the query, does not include content that is requested by the user who submitted the query, or that does not enable the AI model to generate a response that provides an accurate answer requested by the user.

In some embodiments, the framework described herein may provide mechanisms for improving the performance of the retrieval module in retrieving relevant information for a given user query. For example, since the user queries are typically generated by users during a chat session, the user queries may not be optimal for querying the corpus for retrieving relevant information (e.g., the user queries may not include all of the relevant keywords, the user queries may not provide the necessary context, the user queries may include typographical errors, etc.). As such, the framework may include a query generation module (also referred to herein as a “query condenser module” or a “query condenser model”) configured to reformulate the user query for querying the corpus. The reformulated query may improve the user query by providing sufficient context and correcting any typographical mistakes, such that the reformulated query can be used by the retrieval module more effectively in retrieving relevant documents for the user.

In some embodiments, the query generation module may be (or may include) a machine learning (ML) model (e.g., another AI model, such as a large language model, etc.). As such, the query generation module may be trained using training data to generate queries based on an input query provided by a user and a context associated with the input query. As a user exchanges utterances (such as via text or voice) with the chat system, the chat system may monitor the discussion and determine whether a query has been submitted by the user. If a query has been submitted, the chat system may determine a context surrounding the query based on utterances that are exchanged during the chat session, and provide the user query and the context to the query generation module.

For example, a user may initially provide information about a transaction in an utterance during a chat session, such as “here is my transaction information: transaction ID: 2GC001 in the amount of $81.36 on May 18.” The user may subsequently ask the chat system, “explain status” in the chat session. In this example, the user generated query “explain status” is a poorly drafted query for the AI model, since the query does not include any information that can be used by the AI model to generate a response. Furthermore, the user generated query is also a poorly drafted query for the retrieval module, as the query is vague in nature and would cause the retrieval module to fail in retrieving any useful information for the AI model or retrieving irrelevant or inaccurate information for the AI model.

As such, the chat system may use the query generation module to reformulate the user query before providing the reformulated query to the retrieval module. The chat system may first derive a context for the user query based on other utterances that are exchanged during the chat session. In this example, since the user has provided information that can be used to identify a particular transaction before providing the user query “explain status,” the chat system may extract the information from the user utterances submitted prior to the user query as a context to the user query, and provide the user query and the context to the query generation module. An example reformulated query that can be used by the retrieval module and/or the AI model to generate a meaningful response to the user query may include “explain the status of this transaction: ID 2GC001, amount $81.36, date: May 18, from my account.” The reformulated query may be provided to the retrieval module for retrieving relevant documents from the corpus. The relevant documents, along with the user query and/or the reformulated query may then be provided to the AI model to generate a response for the user. The response may be transmitted to a device of the user as part of the chat session between the user and the chat system.

As discussed herein, the query generation module may be trained to reformulate the user query based on the provided context. However, due to the required response time for producing the reformulated query (e.g., which corresponds to the required response time for responding to the user in a chat session), the ML model associated with the query generation module may be configured to favor speed over quality. For example, in order to provide faster response time (e.g., providing responses within a time threshold, etc.), the query generation module may be implemented using a machine learning model structure that is simpler but faster in response time (e.g., having a number of parameters less than a threshold), instead of a more complex structure (e.g., having a number of parameters more than the threshold) that is slower. The simpler ML model, while capable of reformulating the user query within a shorter time frame, may initially have a lower performance level (e.g., generating reformulated queries that are below a quality threshold according to a set of criteria, etc.). Using the example illustrated above, the simpler ML model may generate a reformulated query: “explain status of a transaction.” While this reformulated query is a more detailed version of the original user query, it still may not provide sufficient details for the retrieval module to retrieve as much useful information as the more complicated ML model for the AI model to generate a meaningful response.

As such, in order to improve the quality of the reformulated queries produced by the query generation module, while maintaining a simpler machine learning model structure, the framework may provide different mechanisms to improve the performance of the query generation module. In some embodiments, the framework may enable the chat system to improve the performance of the query generation module through prompt engineering. Prompt engineering is a process of improving the outputs of a large language model (e.g., the query generation module) through optimizing the quality of an input prompt. For example, the chat system may determine a set of guidelines (e.g., in the form of guiding questions, etc.) that can be provided to the query generation module in a prompt along with the user query and the context, which would enable the query generation module to improve the quality of the reformulated queries. The set of guidelines may include specificity of areas in the user query that can be improved, such as determining a category of the user intent (e.g., a transaction dispute, an inquiry to a transaction, how to perform a specific function, etc.), determining the type of information that is missing in the user query based on the determined category, etc. With the set of guidelines, the query generation module may have a focus on one or more different ways to improve on the original user query. However, the prompt engineering approach has several limitations. For example, for a complex task such as query reformulation, there may be a large number of scenarios to cover, and many edge cases that cannot be accurately described through prompting without overly expanding the prompt. Furthermore, complex prompts can be challenging for large language models that are smaller in scale (e.g., models with parameters less than a threshold). As such, the simpler ML model associated with the query generation module may not have enough capability to digest and process complex prompts.

As such, instead of or in addition to prompt engineering, the framework provides an approach of continuously fine-tuning the query generation module in small increments such that the query generation module may continuously improve the quality of the generated reformulated queries. In some embodiments, fine-tuning the query generation module is defined as training the query generation module using a small training dataset (e.g., an amount of training data that is below a threshold amount, etc.). Through repeatedly training the query generation module using different small batches of training datasets, the performance of the query generation module can be incrementally improved. In some embodiments, the framework includes a teacher module as a source of information for fine-tuning the query generation module. The teacher module may also be a machine learning model (e.g., a large language model). In some embodiments, the teacher module includes a more complex machine learning model structure than the query generation module. For example, the teacher module may include more parameters than the query generation module by a threshold (e.g., the teacher module may include billions of parameters while the query generation module may include only millions of parameters, etc.).

In some embodiments, the teacher module evaluates the reformulated queries generated by the query generation module, and generates improved versions of the reformulated queries. For example, the chat system may obtain chat logs associated with conversations conducted between various users and the chat system over a period of time. The chat system may identify, from the chat logs, a user query that have been reformulated by the query generation module for use by the retrieval module and/or the AI model. The chat system may provide (i) the user query, (ii) a chat history associated with the user query (e.g., utterances that have been exchanged between the user and the chat system during the same chat session as the user query, etc.), and (iii) the reformulated query generated by the query generation module based on the user query to the teacher module.

The teacher module may evaluate the reformulated query based on the original user query and the chat history, and may generate a score that indicates a quality of the reformulated query and an explanation related to one or more reasons why the reformulated query is associated with the score (e.g., why the reformulated query is of low quality, etc.). In some embodiments, the teacher module may be trained to evaluate the reformulated query based on a set of criteria. The set of criteria may include criteria for being a high-quality query, such as (1) indicating the intent of the user, (2) including a context associated with the chat history that is relevant to the user query, (3) excluding context information from the chat history that is no longer relevant to the user query, and (4) being concise. The set of criteria may also include criteria for being a low-quality query, such as (1) missing context information from the chat history that is relevant to the user query, (2) answering the user query instead of rephrasing it, and (3) failing to elaborate the demonstrative pronouns in the user query such as “it”, “this”, “that” from the chat history.

If the score generated by the teacher module is below a threshold (indicating that the reformulated query generated by the query generation module is below a quality level), the chat system may provide the score and the explanation (in addition to the original user query, the chat history, and the reformulated query) back to the teacher module, and instruct the teacher module to generate an improved version of the reformulated query. Using the example illustrated above, the improved version of the reformulated query based on the user query “explain status” may be “explain the status of this transaction: ID2GC001, amount $81.36, date: May 18, from my account.” The chat system may then use the improved version of the reformulated query generated by the teacher module to re-train the query generation module. For example, the chat system may generate training data to include the original user query “explain status,” the context associated with the query, and the improved version of the reformulated query. By training the query generation module using the training data in the fine-tuning process, it manipulates the parameters within the query generation module such that the query generation module generates a reformulated query that is similar to the one included in the training data based on the user query and the context.

In some embodiments, the teacher module assigns a score to the improved version of the reformulated query, and may label the improved version of the reformulated query in the training data (which includes the original user query, the context, and the improved version of the reformulated query) based on the score for training/retraining the query generation module. For example, the teacher module may label the improved version of the reformulated query based on a range of labels (e.g., very weak, weak, medium, strong, very strong, etc., which can be designated by numerical values, such as, respectively, 1, 2, 3, 4, 5, etc.). The higher the score that the improved version of the reformulated query receives, a better label is assigned to the query. In some embodiments, the teacher module may also generate another training data set based on the reformulated query generated by the query generation module. For example, if the quality of the reformulated query generated by the query generation module is below a threshold (e.g., having a score below a threshold, etc.), the teacher module may generate the training dataset as a negative training material. The teacher module may assign a bad label (e.g., weak or very weak, etc., which can be designated by numerical values) to the reformulated query, and include it in the training dataset that also includes the original user query and the context. The chat system may use both training datasets to train/retrain the query generation module.

The chat system may continue to extract sample queries from different chat sessions, and use the teacher module to generate improved versions of reformulated queries as training data for retraining the query generation module. The continuous retraining of the query generation module may enable the query generation module to steadily improve the quality of its performance over time.

In some embodiments, instead of using all of the queries from a chat logs, the chat system may select only a subset of the queries for training/retraining the query generation module in the fine-tuning process. For example, the chat system may identify queries that resulted in low quality responses from the AI model for retraining purposes. In some embodiments, the chat system determines that a query has resulted in a low-quality response from the AI model based on subsequent interactions between the user and the chat system. For example, if the chat system determines that the user repeats the same user query or submits a rephrased version of the user query, the chat system may determine that the response provided by the AI model is low in quality. The chat system may then select the user queries from the chat logs that result in low-quality responses for retraining the query generation module.

In some embodiments, the chat system may also selectively extract representative sample queries that represent various topics associated with the conversations in the chat logs. In this regard, the chat system may cluster the chat conversations from the chat logs, such that each cluster corresponds to a distinct topic of conversations. The chat system may then select representative sample queries from each of the cluster (e.g., substantially the same number of queries from each cluster, etc.), such that the chat system can use the teacher module to generate training data (e.g., using the teacher module to generate improved versions of reformulated queries, etc.) that covers the spectrum of topics associated with the domain. The chat system may then use the training data to retrain the query generation module.

After extracting the representative sample queries and using the sample queries to retrain the query generation module, the chat system may continue to obtain additional chat logs (e.g., chat logs associated with subsequent time periods, etc.) to generate additional training data for retraining the query generation module. In order to maintain the diversity of training data, the chat system may select, from the chat logs, queries that are dissimilar to the queries used in the pre-existing training dataset. The chat system may then use the teacher module to generate new training data (e.g., using the teacher module to generate improved versions of reformulated queries, etc.), and retrain the query generation module. In some embodiments, the chat system periodically retrains the query generation module using new training data sets that are generated based on data from new chat logs. The continuous retraining of the query generation module using diverse sample queries that are in in low quantity (e.g., having a number of queries below a threshold) provides incremental improvements to the query generation module, such that the query generation module may incrementally improve its performance in reformulating queries toward the performance level of the teacher module (e.g., generating reformulated queries with a quality that is substantially similar to what the teacher module would produce, etc.) while maintaining the required response time (e.g., responding within a time threshold) and without requiring substantial offline training periods. The reformulated query may then be used to retrieve information relevant to the original user query, and may then be used by the AI model to generate a response to the user query. As such, the framework as discussed herein provides improvements in how the AI model may generate responses to user queries (e.g., improvements in the speed and quality of the responses).

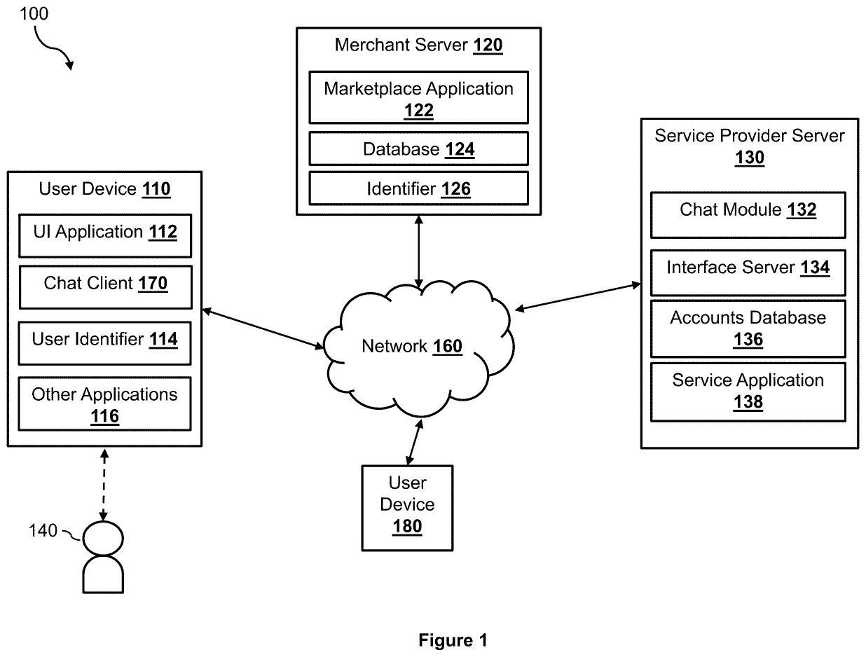

FIG. 1 illustrates an electronic transaction system 100, within which the framework may be implemented according to one or more embodiments of the disclosure. The electronic transaction system 100 includes a service provider server 130, a merchant server 120, and user devices 110 and 180 that may be communicatively coupled with each other via a network 160. The network 160, in one embodiment, is implemented as a single network or a combination of multiple networks. For example, in various embodiments, the network 160 includes the Internet and/or one or more intranets, landline networks, wireless networks, and/or other appropriate types of communication networks. In another example, the network 160 comprises a wireless telecommunications network (e.g., cellular phone network) adapted to communicate with other communication networks, such as the Internet.

The user device 110, in one embodiment, is utilized by a user 140 to interact with the merchant server 120 and/or the service provider server 130 over the network 160. For example, the user 140 uses the user device 110 to conduct an online transaction, such as a purchase, interaction with a merchant or other entity, or data/content access, with the merchant server 120 via websites hosted by, or mobile applications associated with, the merchant server 120. The user 140 also logs in to a user account to access account services or conduct electronic transactions (e.g., data access, account transfers or payments, etc.) with the service provider server 130. The user device 110, in various embodiments, is implemented using any appropriate combination of hardware and/or software configured for wired and/or wireless communication over the network 160. In various implementations, the user device 110 includes at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110 may also include a chat client 170 for facilitating online chat sessions with another chat client (e.g., a chat client of another device, such as the user device 180 or the merchant server 120, the chat module 132 of the service provider server 130, etc.). The chat client 170 may be a software application executed on the user device 110 for providing a chat client interface for the user 140 and for exchanging (e.g., transmitting and receiving) messages with the other chat client (either via a peer-to-peer chat protocol or via a chat server). For example, during an online chat session with the chat module 132, the chat client 170 presents a chat interface that enables the user 140 to input data (e.g., text data such as utterances, audio data, multi-media data, etc.) for transmitting to the chat module 132. The chat interface of the chat client 170 may also present messages that are received from the chat module 132. In some embodiments, the messages are presented on the chat client interface in a chronological order according to a chat flow of the online chat session. The chat client 170 may be an embedded application that is embedded within another application, such as the UI application 112. Alternatively, the chat client 170 may be a stand-alone chat client program (e.g., a mobile app such as WhatsApp®, Facebook® Messenger, iMessages®, etc.) that is not associated with any other software applications executed on the user device 110.

The user device 110, in various embodiments, includes other applications 116 as may be desired in one or more embodiments of the present disclosure to provide additional features available to the user 140. In one example, such other applications 116 include security applications for implementing client-side security features, programmatic client applications for interfacing with appropriate application programming interfaces (APIs) over the network 160, and/or various other types of generally known programs and/or software applications. In still other examples, the other applications 116 interface with the user interface application 112 and/or the chat client 170 for improved efficiency and convenience.

The user device 110, in one embodiment, includes at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to conduct a purchase transaction with the merchant server 120 and/or the service provider server 130, to initiate a chargeback transaction request, etc.). In another example, the user 140 may use the input component to interact with the chat client 170 (e.g., to provide utterances to be transmitted to other chat clients, to a chat server, etc.). Utterances can be provided or initiated via text or audio. The user 140 may transmit questions/inquiries, and/or requests for performing certain tasks/transactions using the input component. In some embodiments, if the chat client 170 is integrated within another application (e.g., the UI application 112, etc.), the chat client may automatically access account data of the user via a platform (e.g., a website, etc.) accessed by the UI application, and may provide the relevant account data to another chat client or a chat server for performing the tasks/transactions.

The user device 180 may include substantially the same hardware and/or software components as the user device 110, which may be used by a user to interact with the merchant server 120 and/or the service provider server 130.

The merchant server 120, in various embodiments, may be maintained by a business entity (or in some cases, by a partner of a business entity that processes transactions on behalf of the business entity). Examples of business entities include merchants, resource information providers, utility providers, online retailers, real estate management providers, social networking platforms, a cryptocurrency brokerage platform, etc., which offer various items, content, and/or services for purchase and process payments for the purchases. The merchant server 120 may include a merchant database 124 for identifying available items, content, or services, which may be made available to the user devices 110 and 180 for viewing and purchase by the respective users.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 (or the user of the user device 180) may interact with the marketplace application 122 through the user interface application 112 over the network 160 to search and view various items, content, or services available for purchase in the merchant database 124. The merchant server 120, in one embodiment, includes at least one merchant identifier 126, which may be included as part of the one or more items, content, or services made available for purchase so that, e.g., particular items and/or transactions are associated with the particular merchants. In one implementation, the merchant identifier 126 includes one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, is maintained by a transaction processing entity or an online service provider, which provides processing of electronic transactions between users (e.g., the user 140 and users of other user devices, etc.) and/or between users and one or more merchants. As such, the service provider server 130 includes a service application 138, which may be adapted to interact with the user device 110, user device 180, and/or the merchant server 120 over the network 160 to facilitate the electronic transactions (e.g., electronic payment transactions, data access transactions, interactions, such as chat sessions, etc.) among users and merchants processed by the service provider server 130. In one example, the service provider server 130 is provided by PayPal®, Inc., of San Jose, California, USA, and/or one or more service entities or a respective intermediary that provide multiple point of sale devices at various locations to facilitate transaction routings between merchants and, for example, service entities.

In some embodiments, the service application 138 includes a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 also includes an interface server 134 that is configured to serve content (e.g., web content) to users and interact with users. For example, the interface server 134 includes a web server configured to serve web content in response to HTTP requests. In another example, the interface server 134 includes an application server configured to interact with a corresponding application (e.g., a service provider mobile application) installed on the user devices 110 and 180 via one or more protocols (e.g., RESTAPI, SOAP, etc.). As such, the interface server 134 may include pre-generated electronic content ready to be served to users. For example, the interface server 134 stores a log-in page and is configured to serve the log-in page to users for logging into user accounts of the users to access various services provided by the service provider server 130. The interface server 134 may also include other electronic pages associated with the different services (e.g., electronic transaction services, etc.) offered by the service provider server 130. As a result, a user (e.g., the user 140, the user of the user device 180, or a merchant associated with the merchant server 120, etc.) may access a user account associated with the user and access various services offered by the service provider server 130, by generating HTTP requests directed at the service provider server 130.

The service provider server 130, in one embodiment, is configured to maintain one or more user accounts and merchant accounts in an accounts database 136, each of which may be associated with a profile and may include account information associated with one or more individual users (e.g., the user 140 associated with user device 110, the user associated with the user device 180, etc.) and merchants. For example, account information includes private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions. It is noted that the accounts database 136 (and/or any other database used by the system disclosed herein may be implemented within the service provider server 130 or external to the service provider server 130 (e.g., implemented in a cloud, etc.).

In one implementation, a user has identity attributes stored with the service provider server 130, and the user has credentials to authenticate or verify identity with the service provider server 130. User attributes may include personal information, banking information and/or funding sources. In various aspects, one or more of the user attributes are passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a chat module 132 that implements the chat system as discussed herein. In some embodiments, the chat module 132 may provide a user interface on devices (e.g., the user device 110, the user device 180, the merchant server 120, etc.) that enables users to submit utterances, such as questions related to an organization associated with the service provider server 130, requests for performing a transaction, etc. For example, the chat module 132 may include or have access to a chat server (not shown) that can facilitate and maintain chat sessions with different chat clients (e.g., the chat client 170, and other chat clients). The chat module 132 may use the chat server to establish chat sessions with different chat clients, and conduct conversations with different users via the chat sessions.

Based on the user inputs (e.g., utterances submitted by the user via a chat interface from voice or text), the chat module 132 may generate content in response to the user inputs. For example, when the user 140 of the user device 110 submits an utterance “how do I file a dispute for a transaction,” the chat module 132 may generate content (e.g., a response, etc.) related to instructions on how to file a dispute based on information related or specific to the organization, and may transmit the generated content to the user via the chat interface as a response to the user inputs. In another example, when the user 140 of the user device 110 submits an utterance “I want to file a dispute for a transaction,” the chat module 132 may generate content (e.g., one or more prompts, etc.) that asks the user for information required to process a dispute (e.g., a selection of a particular transaction that the user wants to dispute, a reason for the dispute, etc.), and may process the transaction (e.g., the dispute transaction) for the user based on the information.

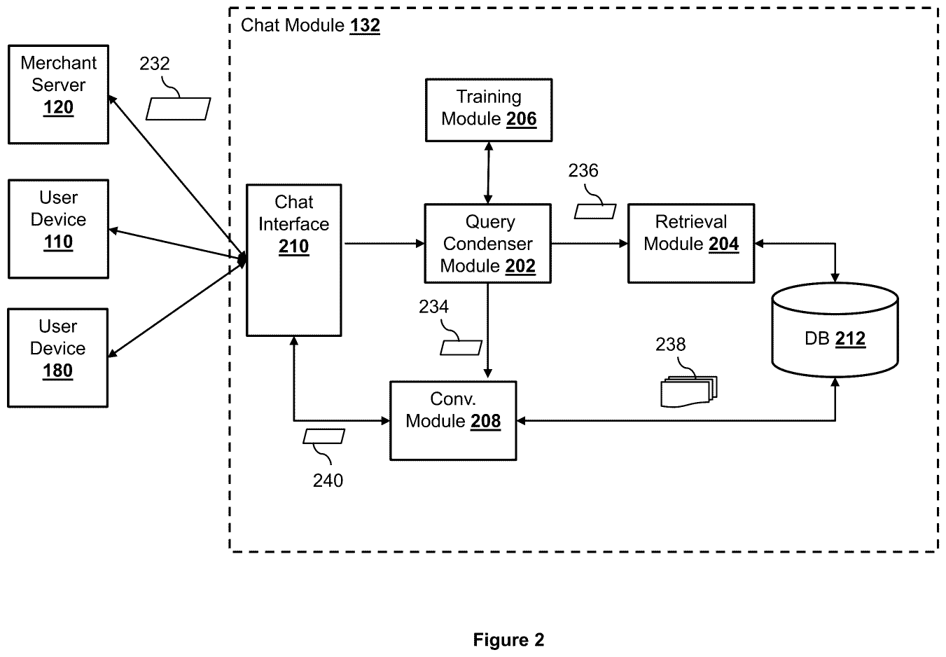

FIG. 2 illustrates a block diagram of the chat module 132 according to an embodiment of the disclosure. The chat module 132 includes a query condenser module 202, a retrieval module 204, a training module 206, a conversation module 208, a chat interface 210, and a database 212. The chat interface 210 may be configured to establish and/or maintain communication sessions (also referred to as “chat sessions”) with various chat clients of different user devices, such as the chat client 170 of the user device 110, a chat client of the merchant server 120, a chat client of the user device 180, etc. For example, when the user 140 uses the chat client 170 to initiate a chat session with the chat module 132, the chat interface 210 may establish a chat session with the chat client 170 using a particular protocol, which includes performing one or more handshakes with the chat client 170 to establish and assign a chat identifier to the chat session. The chat interface 210 may also maintain a communication with the chat client 170 until the chat session is terminated by either the chat module 132 or the chat client 170. As such, the chat module 132 may exchange utterances during a chat session. For example, the chat module 132 may receive an utterance 232 from a user of the service provider server 130 (e.g., the user 140) via the chat interface 210 during a chat session. The utterance 232 may include a question, a phrase, and/or a sentence in a natural language format. When the utterance 232 includes a question or a request, the utterance 232 may be referred to as a “query” or a “user query.” The chat module 132 may use the conversation module 208 to generate a response 240 to the utterance 232, in a way to continue or advance a conversation (e.g., one or more turns of questions and answers, etc.) with the user.

In some embodiments, the conversation module 208 is an AI model that is configured to provide information specific to a service provider associated with the service provider server 130 to users via the chat interface 210. As discussed herein, AI models are typically trained to provide generic information about a wide range of domains, but are not trained to provide responses that are specific to any particular domain (e.g., not trained to provide information related to specific processes, procedures, and policies associated with a particular organization, etc.). As such, in order to enhance the ability of the conversation module 208 to provide information specific to the service provider, the chat module 132 may use the framework as discussed herein to provide enriched information that is specific to the service provider and relevant to the user queries to the conversation module 208, such that the conversation module 208 may generate a response that is specific to the service provider and relevant to the user queries.

In this regard, the chat module 132 may compile documents (e.g., white papers, webpages, articles, internal instructions, etc.) associated with the service provider and store the documents in the database 212. Documents, as used herein, may be in any format (digital/electronic or non-digital/physical) that includes data, content, or information, which can have or not have size limits. In some embodiments, the service provider excludes any documents that are not part of the service provider in the corpus. As such, the database 212 includes information that can be retrieved and provided to the conversation module 208, to assist the conversation module 208 to generate relevant and useful responses to user queries. For example, as the chat module 132 receives the utterance 232 from the user device 110 via the chat interface 210, the chat module 132 may use the retrieval module 204 to retrieve documents 238 from the database 212 that are relevant to the utterance 232, and provide the utterance 232 along with the documents 238 to the conversation module 208. The conversation module 208 may then generate a response 240 to the utterance 232 based on the information included in the documents 238. This way, the chat module 132 can ensure that the response 240 generated by the conversation module 208 is specific to a particular domain (e.g., specific to the service provider and not related to other environments external to the service provider). The chat module 132 may also or instead ensure responses generated by the conversation module 208 is specific to a merchant associated with the merchant server 120 or other entities or groups of entities using processes described herein.

Since the conversation module 208 generates responses based on the information retrieved by the retrieval module, the quality of the response is largely dependent on the quality of the information (e.g., the amount of information included in the additional information, the relevancy of the additional information to the user query, the type of information of the additional information, etc.) and therefore, the performance of the retrieval module. As defined herein, information is relevant to the query/utterance when the information includes content that is associated with the query/utterance (e.g., information that is usable to answer the query, etc.), content that is requested by the user, or that is usable by the conversation module 208 to generate a response that provides an answer requested by the user. Information is irrelevant to the query/utterance when the information is not associated with the query/utterance, does not include content that is requested by the user who submitted the query/utterance, or that does not enable the conversation module 208 to generate a response that provides an answer requested by the user.

In some embodiments, the retrieval module 204 uses the utterance 232 (e.g., user-generated query) to retrieve documents from the database 212 for the conversation module 204. However, the utterance 232 that is generated by user may not always be optimal for querying the database 212 for retrieving relevant information for a number of reasons. For example, the utterance 232 may not include all of the relevant keywords, the utterance 232 may not provide the necessary context, the utterance 232 may include typographical errors, etc. As such, the chat module 132 may use a query condenser module 202 to improve (e.g., to reformulate) the utterance 232 before using the reformulated utterance 236 to query the database 212. The reformulated utterance 236 should correct the issues related to the utterance (e.g., fixing the typographical errors, including the necessary keywords, etc.), and provide sufficient context, such that the retrieval module 204 can use the reformulated utterance 236 to retrieve useful information from the database 212 for the conversation module 208 to generate a response 240.

As the user 140 conducts a conversation with the chat module 132, the chat module 132 may monitor the conversation and determine whether a query has been submitted by the user. If a query has been submitted, the chat system may determine a context surrounding the query based on utterances that are exchanged during the chat session, and provide the user query and the context to the query condenser module 202. The query condenser module 202 may generate a reformulated query based on the user query and the provided context. In some embodiments, the query condenser module 202 may be (or may include) a machine learning (ML) model (e.g., another AI model, such as a large language model, etc.). As such, the query condenser module 202 may be trained using training data to generate queries based on an input query (e.g., the utterance 232) provided by a user and a context associated with the input query.

For example, a user may initially provide information about a transaction in an utterance during a chat session, such as “here is my transaction information: transaction ID: 2GC001 in the amount of $81.36 on May 18.” The user may subsequently ask the chat system, “explain status” in the chat session. In this example, the user generated query (which may correspond to utterance 232) “explain status” is a poorly drafted query for the conversation module 208, since the query does not include any information that can be used by the conversation module 208 to generate a response. Furthermore, the user generated query is also a poorly drafted query for the retrieval module 204, as the query is vague in nature and would cause the retrieval module 204 to fail in retrieving any useful information for the conversation module 208 or retrieving irrelevant or inaccurate information for the conversation module 208.

As such, the chat module 132 may use the query condenser module 202 to reformulate the utterance 132 before providing the reformulated query 236 to the retrieval module 204. The chat module 132 may first derive a context for the utterance 232 based on other utterances that are exchanged during the chat session. In this example, since the user has provided information that can be used to identify a particular transaction before providing the utterance 232 “explain status,” the chat module 132 may extract the information from the user utterances submitted prior to the user query as a context to the utterance 232, and provide the utterance 232 and the context to the query condenser module 202. An example reformulated query 236 that can be used by the retrieval module 204 and/or the conversation module 208 to generate a meaningful response to the user query 232 may include “explain the status of this transaction: ID 2GC001, amount $81.36, date: May 18, from my account.” The reformulated query 236 may be provided to the retrieval module 204 for retrieving relevant documents 238 from the database 212. The relevant documents 238, along with the user query 232 and/or the reformulated query 236 may then be provided to the conversation module 208 to generate a response 240 for the user. The response 240 may be transmitted to a device (e.g., the user device 110, the user device 180, the merchant server 120, etc.) of the user as part of the chat session between the user and the chat module 132.

However, due to the required response time for producing the reformulated query 236 (e.g., which corresponds to the required response time for responding to the user in a chat session), the ML model associated with the query condenser module 202 may be configured to favor speed over quality. For example, in order to provide faster response time (e.g., providing responses within a time threshold, etc.), the query condenser 202 module may be implemented using a machine learning model structure that is simpler but faster in response time (e.g., having a number of parameters less than a threshold), instead of a more complex structure (e.g., having a number of parameters more than the threshold) that is slower. The simpler ML model, while capable of reformulating the user query within a shorter time frame, may initially have a lower performance level (e.g., generating reformulated queries that are below a quality threshold according to a set of criteria, etc.). Using the example illustrated above, the simpler ML model may generate a reformulated query: “explain status of a transaction.” While this reformulated query is a more detailed version of the original user query 232, it still does not provide sufficient details for the retrieval module to retrieve useful information for the AI model to generate a meaningful or more accurate response.

As such, in order to improve the quality of the reformulated queries produced by the query condenser module 202, while maintaining a simpler machine learning model structure for quicker response times, the framework may provide different mechanisms to improve the performance of the query condenser module 202. In some embodiments, under the framework, the chat module 132 may improve the performance of the query condenser module 202 through prompt engineering. Prompt engineering is a process of improving the outputs of a large language model (e.g., the query generation module) through optimizing the quality of an input prompt. For example, the chat module 132 may determine a set of guidelines (e.g., in the form of guiding questions, etc.) that can be provided to the query condenser module 202 in a prompt along with the user query and the context, which would enable the query condenser module 202 to improve the quality of the reformulated queries. The set of guidelines may include specificity of areas in the user query that can be improved, such as determining a category of the user intent (e.g., a transaction dispute, an inquiry to a transaction, how to perform a specific function, etc.), determining the type of information that is missing in the user query based on the determined category, etc. With the set of guidelines, the query condenser module 202 may have a focus on one or more different ways to improve on the original user query. However, the prompt engineering approach has several limitations. For example, for a complex task such as query reformulation, there may be a large number of scenarios to cover, and many edge cases that cannot be accurately described through prompting without overly expanding the prompt. Furthermore, complex prompts can be challenging for large language models that are smaller in scale (e.g., models with parameters less than a threshold), such as the model that is implemented as the query condenser module 202. As such, the query condenser module 202 may not have enough capability to digest and process complex prompts.

As such, instead of or in addition to prompt engineering, the framework provides an approach of continuously fine-tuning the query condenser module 202 in small increments such that the query condenser module 202 may continuously improve the quality of the generated reformulated queries. In some embodiments, the framework provides a training module 206 for continuous training (and re-training) the query condenser module 202.

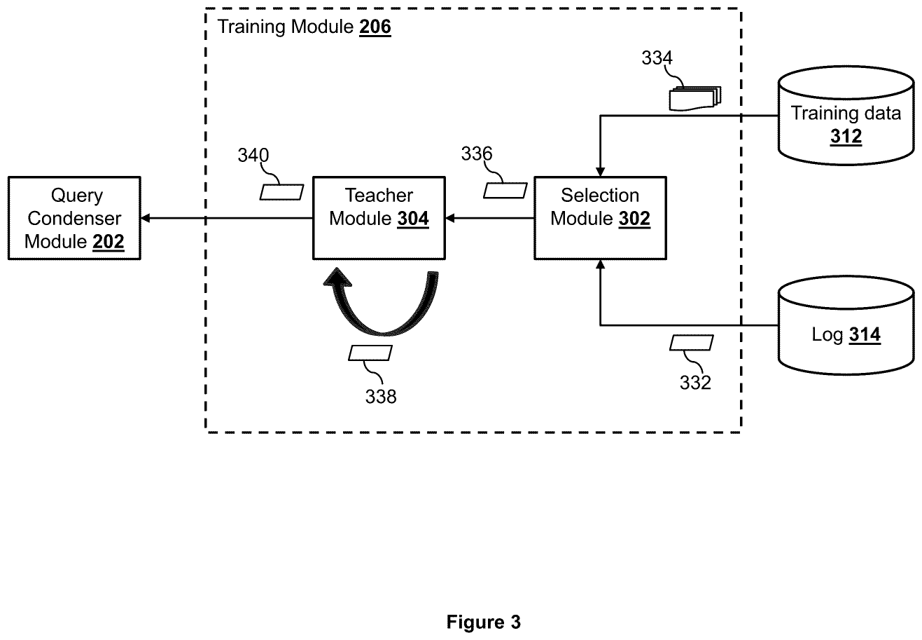

FIG. 3 illustrates a block diagram of the training module 206 according to an embodiment of the disclosure. The training module 206 includes a teacher module 304 and a selection module 302. The teacher module 304 may also be a machine learning model (e.g., a large language model), but includes a more complex machine learning model structure than the query condenser module 202. For example, the teacher module 304 may include more parameters than the query generation module by a threshold (e.g., the teacher module 304 may include billions of parameters while the query condenser module 202 may include only millions of parameters, etc.).

In some embodiments, the teacher module 304 evaluates the reformulated queries generated by the query condenser module 202, and generates improved versions of the reformulated queries. For example, the selection module 302 may obtain, from a log database 314, chat logs 332 associated with conversations conducted between various users and the chat module 132 over a period of time. The selection module 302 may identify, from the chat logs 332, a user query that have been reformulated by the query condenser module 202 for use by the retrieval module 204 and/or the conversation module 208. The selection module 302 may provide data 336 including (i) the user query, (ii) a chat history associated with the user query (e.g., utterances that have been exchanged between the user and the chat system during the same chat session as the user query, etc.), and (iii) the reformulated query generated by the query generation module based on the user query to the teacher module 304.

The teacher module 304 may evaluate the reformulated query generated by the query condenser module 202 based on the original user query and the chat history, and may generate a score that indicates a quality of the reformulated query and an explanation related to one or more reasons why the reformulated query is associated with the score (e.g., why the reformulated query is of low quality, etc.). In some embodiments, the teacher module 304 may be trained to evaluate the reformulated query based on a set of criteria. The set of criteria may include criteria for being a high-quality query, such as (1) indicating the intent of the user, (2) including a context associated with the chat history that is relevant to the user query, (3) excluding context information from the chat history that is no longer relevant to the user query, and (4) being concise. The set of criteria may also include criteria for being a low-quality query, such as (1) missing context information from the chat history that is relevant to the user query, (2) answering the user query instead of rephrasing it, and (3) failing to elaborate the demonstrative pronouns in the user query such as “it”, “this”, “that” from the chat history.

If the score generated by the teacher module 304 is below a threshold (indicating that the reformulated query generated by the query condenser module 202 is below a quality level), the training module 206 may provide data 338 including the score and the explanation (in addition to the original user query, the chat history, and the reformulated query) back to the teacher module 304, and instruct the teacher module 304 to generate an improved version of the reformulated query 340. Using the example illustrated above, the improved version of the reformulated query 340 based on the user query “explain status” may be “explain the status of this transaction: ID 2GC001, amount $81.36, date: May 18, from my account.” In another example, the user may submit a query “it is a payment in 4” to the chat module 132 after the following exchanges between the user and the chat module 132:
User: “I would like to refund the transaction”
Chatbot: “Do you have the transaction ID?”
User: “No”
Chatbot: “You haven't received any transactions in the last 180 days. Let me know what else I can help you with.”

In this example, the query condenser module 202 may generate a reformulated query “I want to refund a payment in 4 transaction” based on the user query and the context derived from the exchanges. The teacher module 304 may provide an improved version of the reformulated query “how can I refund a payment made in 4 installments on XXXX platform?”

The training module 206 may then use the improved version of the reformulated query 340 generated by the teacher module 338 to re-train the query condenser module 202. For example, the training module 206 may generate training data to include the original user query “explain status,” the context associated with the query, and the improved version of the reformulated query. By training the query condenser module 202 using the training data, it manipulates the parameters within the query condenser module 202 such that the query condenser module 202 would generate a reformulated query that is similar to the one included in the training data based on the user query and the context.

The training module 206 may continue to extract sample queries from different chat sessions, and use the teacher module 304 to generate improved versions of reformulated queries as training data for re-training the query condenser module 202. The continuous re-training of the query condenser module 202 may enable the query condenser module 202 to steadily improve the quality of its query reformulation performance over time.

In some embodiments, the training module 206 may selectively extract sample queries from the chat sessions for retraining purposes. For example, the training module 206 may identify queries that resulted in low quality responses from the conversation module 208 for retraining purposes. In some embodiments, the training module 206 determines that a query has resulted in a low-quality response from the conversation module 208 based on subsequent interactions between the user and the chat module 132. For example, if the training module 206 determines that the user repeats the same user query or submits a rephrased version of the user query during the same chat session, the training module 206 may determine that the response provided by the conversation module 208 is low in quality. The training module 208 may then select the user queries from the chat logs 332 that result in low-quality responses for retraining the query condenser module 202.

In some embodiments, the training module 206 may also selectively extract representative sample queries that represent various topics associated with the conversations in the chat logs. By selecting a small number of queries that represent the spectrum of topics in the chat logs, the training module 206 may provide effective training data to the query condenser module 202 while minimizing training time periods (which in turn minimizes downtime or time offline for the query condenser module 202). In this regard, the selection module 302 may cluster the conversations identified in the chat logs, such that each cluster corresponds to a distinct topic of conversations. The selection module 302 may then select representative sample queries from each of the cluster (e.g., substantially the same number of queries from each cluster, etc.), such that the training module 206 can use the teacher module 304 to generate training data 334 (e.g., using the teacher module to generate improved versions of reformulated queries, etc.) that covers the spectrum of topics associated with the organization. The training module 206 may then use the training data 334 to retrain the query condenser module 202. The training module 206 may also store the training data 334 in the training data database 312.

The training module 206 may continue to obtain additional chat logs (e.g., chat logs associated with subsequent time periods, etc.) to generate additional training data for re-training the query condenser module 202. In order to maintain the diversity of training data, the selection module 302 may select, from the chat logs, queries that are dissimilar to the queries used in the pre-existing training data 334 from the training data database 312. The training module 260 may then use the teacher module 304 to generate new training data (e.g., using the teacher module 304 to generate improved versions of reformulated queries, etc.), and retrain the query condenser module 202.

In some embodiments, the training module 206 periodically retrains the query condenser module using new training data sets that are generated based on data from new chat logs. The continuous retraining of the query condenser module 202 using diverse, but in low quantity (e.g., having a number of queries below a threshold), sample queries provides incremental improvements to the query condenser module 202, such that the performance of the query condenser module 202 in reformulating queries may progress toward the performance level of the teacher module 304 (e.g., generating reformulated queries with a quality that is substantially similar to what the teacher module would produce, etc.) while maintaining the required response time (e.g., responding within a time threshold) and without requiring substantial offline training periods. The reformulated query may then be used to retrieve information relevant to the original user query, and may then be used by the conversation model 208 to generate a response to the user query.

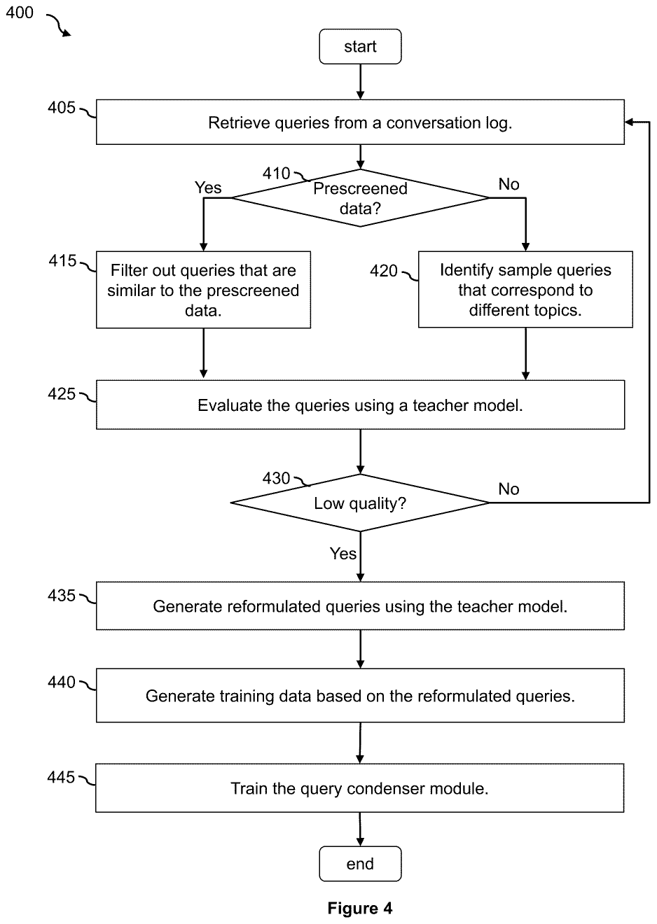

FIG. 4 illustrates a process 400 for training a query condenser module under the framework according to various embodiments of the disclosure. In some embodiments, at least a portion of the process 400 is performed by the chat module 132, although one or more steps may be performed by one or more of the components/devices/modules/systems described herein. The process 400 begins by receiving (at step 405) queries from a conversation log. For example, the training module may obtain queries 332 from the log database 314. In some embodiments, the chat module 132 monitors each conversation conducted between a user and the chat module 132 in a chat session, and stores the chat data (which includes all of the utterances exchanged during the chat session) in the log database 314. As discussed herein, the training module 206 may determine to train or retrain the query condenser module 202 (e.g., periodically or at different predetermined times, etc.). The selection module 302 may obtain the conversations from the log database 314 and may extract queries from the conversations.

In some embodiments, the selection module 302 selects only a portion of the queries for training and/or retraining the query condenser module 202, in order to minimize the amount of training data (and thus, the amount of training time) used to train/retrain the query condenser module 202. For example, the selection module 302 may first determine (at step 410) whether preexisting training data (e.g., prescreened data) has been generated and stored in the training data database 312. If no preexisting training data is stored in the training data database 312, the selection module 302 identifies (at step 420) sample queries that correspond to different topics in the conversations. For example, the selection module 302 may cluster the conversations into different clusters based on attributes associated with the conversations. The attributes may include words used in the conversations, the semantics associated with the words, a label assigned to the conversations, etc. In some embodiments, the selection module 302 uses an AI model to convert each conversation into vectors represent the semantics of the conversations based on the words included in the conversations. The selection module 302 may then cluster the conversations based on the vectors. The selection module 302 may then select representative queries (e.g., a predetermined portion, such as 5%, 2%, etc. of the queries) from each cluster for use in training and/or retraining the query condenser module 202.

On the other hand, if it is determined that preexisting training data is stored in the training data database 312, the selection module 302 filters out (at step 415) queries that are similar to the pre-existing training data. For example, the selection module 302 may compare each of the new queries obtained from the conversation log against the queries in the pre-existing training data. The selection module 302 may only select the queries that are different from the pre-existing training data by a threshold, and filter out the queries that are not different from the pre-existing training data by the threshold.

The training module 206 then uses the teacher module 304 to evaluate (at step 425) the queries and determines (at step 430) whether the reformulated queries generated by the query condenser module 202 for the queries are of low quality. For example, the training module 206 may determine that a reformulated query is of low quality based on utterances exchanged during the same conversation as the query. If a user repeats the same query or provides a different version of the query after obtaining a response generated by the conversation module 208 (the response generated based on information obtained by the retrieval module 204 using the reformulated query), the training module 206 may determine that the reformulated query is of low quality. In some embodiments, the training module 206 uses only the queries that resulted in low-quality reformulated queries for training/retraining the query condenser module 202. As such, if the queries do not correspond to any low-quality reformulated queries, the selection module 302 may revert back to step 405 and retrieves queries from another conversation log (e.g., another conversation log that corresponds to a different time period, etc.). The system may determine how to measure low quality reformulated queries, including how many times it takes to reach a completion point with the user, how often the user reformulates a similar query, etc., where the thresholds can vary based on the user, type of query, etc. This can be part of or be the set of criteria discussed above.

On the other hand, if it is determined that some of the queries correspond to low-quality reformulated queries, the training module 206 may use those queries to train/retrain the query condenser module 202. For example, the training module 206 may use the teacher module 304 to generate (at step 435) reformulated queries based on the queries and the contexts associated with the queries. Since the teacher module 304 is implemented using a more complex machine learning model structure (e.g., has more parameters) than query condenser module 202, the teacher module 304 is capable of producing higher quality of reformulated queries than the query condenser module 202.

The training module 304 then generates (at step 440) training data based on the reformulated queries generated by the teacher module 304 and trains (at step 445) the query condenser module 202 using the training data. In some embodiments, the training module 206 may repeatedly perform the process 400 to train/retrain the query condenser module 202 (e.g., periodically, etc.). By continuously training the query condenser module 202 using reformulated queries generated by the teacher module 304, the performance level of the query condenser module 202 can be incrementally improved.

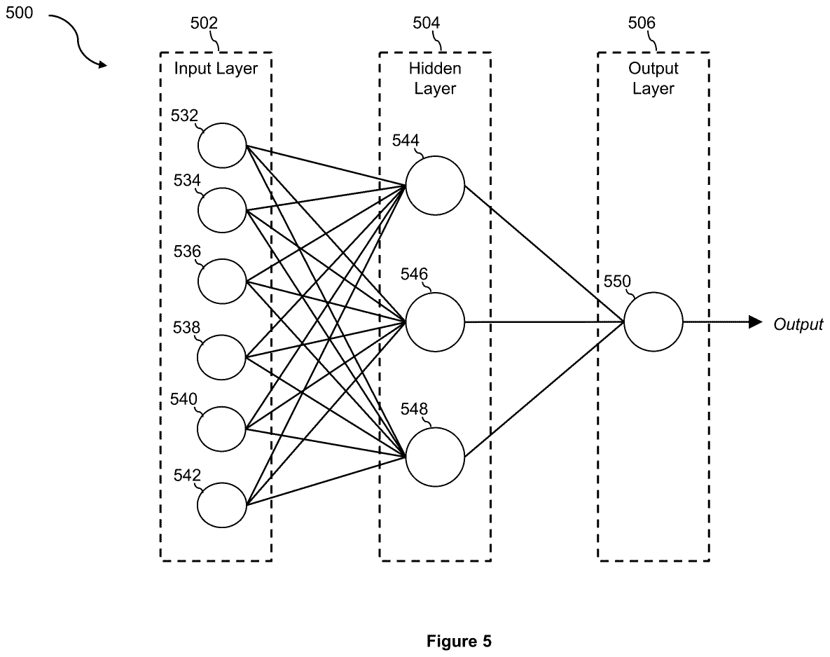

FIG. 5 illustrates an example artificial neural network 500 that may be used to implement a machine learning model, such as the query condenser module 202, the teacher module 304, and the conversation module 208. As shown, the artificial neural network 500 includes three layers-an input layer 502, a hidden layer 504, and an output layer 506. Each of the layers 502, 504, and 506 may include one or more nodes (also referred to as “neurons”). For example, the input layer 502 includes nodes 532, 534, 536, 538, 540, and 542, the hidden layer 504 includes nodes 544, 546, and 548, and the output layer 506 includes a node 550. In this example, each node in a layer is connected to every node in an adjacent layer via edges and an adjustable weight is often associated with each edge. For example, the node 532 in the input layer 502 is connected to all of the nodes 544, 546, and 548 in the hidden layer 504. Similarly, the node 544 in the hidden layer is connected to all of the nodes 532, 534, 536, 538, 540, and 542 in the input layer 502 and the node 550 in the output layer 506. While each node in each layer in this example is fully connected to the nodes in the adjacent layer(s) for illustrative purpose only, it has been contemplated that the nodes in different layers can be connected according to any other neural network topologies as needed for the purpose of performing a corresponding task.

The hidden layer 504 is an intermediate layer between the input layer 502 and the output layer 506 of the artificial neural network 500. Although only one hidden layer is shown for the artificial neural network 500 for illustrative purpose only, it has been contemplated that the artificial neural network 500 used to implement any one of the computer-based models may include as many hidden layers as necessary. The hidden layer 504 is configured to extract and transform the input data received from the input layer 502 through a series of weighted computations and activation functions.

In this example, the artificial neural network 500 receives a set of inputs and produces an output. Each node in the input layer 502 may correspond to a distinct input. For example, when the artificial neural network 500 is used to implement the query condenser module 202, the teacher module 304, and/or the conversation module 208, the nodes in the input layer 502 may correspond to representations of a prompt. The prompt may be generated to include a user-generated query and a context associated with the query for the query condenser module 202 and/or the teacher module 304. The prompt may be generated to include a user-generated query and documents retrieved by the retrieval module 204 for the conversation module 208.

In some embodiments, each of the nodes 544, 546, and 548 in the hidden layer 504 generates a representation, which may include a mathematical computation (or algorithm) that produces a value based on the input values received from the nodes 532, 534, 536, 538, 540, and 542. The mathematical computation may include assigning different weights (e.g., node weights, edge weights, etc.) to each of the data values received from the nodes 532, 534, 536, 538, 540, and 542, performing a weighted sum of the inputs according to the weights assigned to each connection (e.g., each edge), and then applying an activation function associated with the respective node (or neuron) to the result. The nodes 544, 546, and 548 may include different algorithms (e.g., different activation functions) and/or different weights assigned to the data variables from the nodes 532, 534, 536, 538, 540, and 542 such that each of the nodes 544, 546, and 548 may produce a different value based on the same input values received from the nodes 532, 534, 536, 538, 540, and 542. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 502 is transformed into rather different values indicative data characteristics corresponding to a task that the artificial neural network 500 has been designed to perform.

In some embodiments, the weights that are initially assigned to the input values for each of the nodes 544, 546, and 548 may be randomly generated (e.g., using a computer randomizer). The values generated by the nodes 544, 546, and 548 may be used by the node 550 in the output layer 506 to produce an output value (e.g., a response to a user query, a prediction, etc.) for the artificial neural network 500. The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class. When the artificial neural network 500 is used to implement the query condenser module 202 and/or the teacher module 304, the output node 550 (or multiple output nodes) may be configured to generate representations of a reformulated query. When the artificial neural network 500 is used to implement the conversation module 208, the output node 550 (or multiple output nodes) may be configured to generate representations of a response to a user query.

In some embodiments, the artificial neural network 500 may be implemented on one or more hardware processors, such as CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware used to implement the neural network structure is specifically configured based on factors such as the complexity of the neural network, the scale of the tasks (e.g., training time, input data scale, size of training dataset, etc.), and the desired performance.

The artificial neural network 500 may be trained by using training data based on one or more loss functions and one or more hyperparameters. By using the training data to iteratively train the artificial neural network 500 through a feedback mechanism (e.g., comparing an output from the artificial neural network 500 against an expected output, which is also known as the “ground-truth” or “label”), the parameters (e.g., the weights, bias parameters, coefficients in the activation functions, etc.) of the artificial neural network 500 may be adjusted to achieve an objective according to the one or more loss functions and based on the one or more hyperparameters such that an optimal output is produced in the output layer 506 to minimize the loss in the loss functions. Given the loss, the negative gradient of the loss function is computed with respect to each weight of each layer individually. Such negative gradient is computed one layer at a time, iteratively backward from the last layer (e.g., the output layer 506 to the input layer 502 of the artificial neural network 500). These gradients quantify the sensitivity of the network's output to changes in the parameters. The chain rule of calculus is applied to efficiently calculate these gradients by propagating the gradients backward from the output layer 506 to the input layer 502.

Parameters of the artificial neural network 500 are updated backwardly from the last layer to the input layer (backpropagating) based on the computed negative gradient using an optimization algorithm to minimize the loss. The backpropagation from the last layer (e.g., the output layer 506) to the input layer 502 may be conducted for a number of training samples in a number of iterative training epochs. In this way, parameters of the artificial neural network 500 may be gradually updated in a direction to result in a lesser or minimized loss, indicating the artificial neural network 500 has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as to predict a frequency of future related transactions.

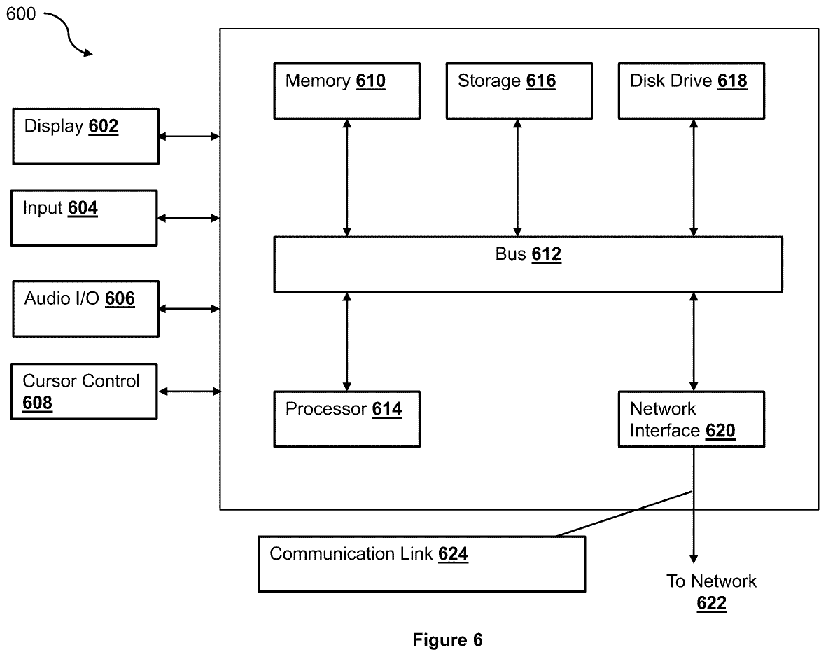

FIG. 6 is a block diagram of a computer system 600 suitable for implementing one or more embodiments of the present disclosure, including the service provider server 130, the merchant server 120, the user device 180, and the user device 110. In various implementations, each of the user devices 110 and 180 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, 130, and 180 may be implemented as the computer system 600 in a manner as follows.

The computer system 600 includes a bus 612 or other communication mechanism for communicating information data, signals, and information between various components of the computer system 600. The components include an input/output (I/O) component 604 that processes a user (i.e., sender, recipient, service provider) action, such as selecting keys from a keypad/keyboard, selecting one or more buttons or links, etc., and sends a corresponding signal to the bus 612. The I/O component 604 may also include an output component, such as a display 602 and a cursor control 608 (such as a keyboard, keypad, mouse, etc.). The display 602 may be configured to present a login page for logging into a user account or a checkout page for purchasing an item from a merchant. An optional audio input/output component 606 may also be included to allow a user to use voice for inputting information by converting audio signals. The audio I/O component 606 may allow the user to hear audio. A transceiver or network interface 620 transmits and receives signals between the computer system 600 and other devices, such as another user device, a merchant server, or a service provider server via a network 622. In one embodiment, the transmission is wireless, although other transmission mediums and methods may also be suitable. A processor 614, which can be a micro-controller, digital signal processor (DSP), or other processing component, processes these various signals, such as for display on the computer system 600 or transmission to other devices via a communication link 624. The processor 614 may also control transmission of information, such as cookies or IP addresses, to other devices.

The components of the computer system 600 also include a system memory component 610 (e.g., RAM), a static storage component 616 (e.g., ROM), and/or a disk drive 618 (e.g., a solid-state drive, a hard drive). The computer system 600 performs specific operations by the processor 614 and other components by executing one or more sequences of instructions contained in the system memory component 610. For example, the processor 614 can perform the automated chat functionalities described herein, for example, according to the process 400.

Logic may be encoded in a computer readable medium, which may refer to any medium that participates in providing instructions to the processor 614 for execution. Such a medium may take many forms, including but not limited to, non-volatile media, volatile media, and transmission media. In various implementations, non-volatile media includes optical or magnetic disks, volatile media includes dynamic memory, such as the system memory component 610, and transmission media includes coaxial cables, copper wire, and fiber optics, including wires that comprise the bus 612. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 600. In various other embodiments of the present disclosure, a plurality of computer systems 600 coupled by the communication link 624 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors coupled with the non-transitory memory and configured to execute instructions from the non-transitory memory to cause the system to:
obtain a first query from a conversation log, the first query generated by a first artificial intelligence (AI) model based on (i) a second query received from a user device and (ii) a context associated with the second query, the first AI model being trained using outputs from a second AI model;
evaluate, using the second AI model different from the first AI model, a quality of the first query based on a set of criteria;
in response to determining that the quality of the first query does not satisfy the set of criteria, generate, using the second AI model and based on the second query and the context, a third query that satisfies the set of criteria; and
retrain the first AI model using the third query generated by the second AI model.

2. The system of claim 1, wherein the second AI model has more parameters than the first AI model by a threshold.

3. The system of claim 1, wherein the second query is received from the user device during a chat session established between the user device and a chat system, wherein executing the instructions further causes the system to:
retrieve one or more utterances exchanged between the user device and the chat system during the chat session; and
derive the context associated with the second query based on the one or more utterances.

4. The system of claim 1, wherein executing the instructions further causes the system to:
retrieve, from a data storage, information based on the first query;
generate a prompt for a third AI model based on the second query, the context, and the information; and
provide the prompt to the third AI model.

5. The system of claim 4, wherein the third AI model is a chat model configured to conduct a conversation with a user of the user device.

6. The system of claim 4, wherein the second query is received from the user device during a chat session established between the user device and a chat system, wherein executing the instructions further causes the system to:
obtain an output from the third AI model based on the prompt; and
transmit, to the user device, the output as a response to the second query during the chat session.

7. The system of claim 1, wherein executing the instructions further causes the system to:
generate training data based on the second query, the context, and the third query generated by the second AI model, wherein retraining the first AI model is based on the training data.

8. A method comprising:
determining, by a computer system, that a user-generated query submitted by a user of a user deice has resulted in a response that does not satisfy a set of criteria;
accessing, by the computer system, a first reformulated query generated by a query condenser model based on the user-generated query and a context associated with the user-generated query, wherein the first reformulated query was used by a chat system to generate the response, and wherein the query condenser model was trained to generate the first reformulated query using outputs generated by a teacher model;
generating, by the computer system and using the teacher model, a second reformulated query based on the user-generated query and the context; and
retraining, by the computer system, the query condenser model using the second reformulated query.

9. The method of claim 8, wherein the user-generated query is part of a conversation log comprising a plurality of queries, wherein the method further comprises:
accessing a plurality of training datasets used to train the query condenser model;
determining, for each query in the plurality of queries, a similarity between the query and the plurality of pre-screened datasets; and
selecting, from the plurality of queries, the user-generated query based on the user-generated query having a lowest similarity with the plurality of training datasets.

10. The method of claim 8, wherein the user-generated query is part of a plurality of utterances exchanged between the user device and the chat system during a chat session, wherein the method further comprises:
analyzing the plurality of utterances exchanged between the user device and the chat system, wherein the determining that the user-generated query does not satisfy the set of criteria is based on the analyzing.

11. The method of claim 8, further comprising:
generating a first training dataset based on the user-generated query, the context, and the second reformulated query assigned with a positive label, wherein the retraining the query condenser model is based on the first training dataset.

12. The method of claim 8, further comprising:
generating a second training dataset based on the user-generated query, the context, and the first reformulated query assigned with a negative label, wherein the retraining the query condenser model is based on the second training dataset.

13. The method of claim 8, wherein the teacher model has more parameters than the query condenser model by a threshold.

14. The method of claim 8, wherein the user-generated query is part of a plurality of utterances exchanged between the user device and the chat system during a chat session, wherein the method further comprises:
determining a context associated with the user-generated query based on the plurality of utterances.

15. A non-transitory machine-readable medium having stored thereon machine-readable instructions executable to cause a machine to perform operations comprising:
obtaining a first reformulated query generated by a query condenser model based on (i) a user-generated query received from a user device and (ii) a context associated with the user-generated query, the query condenser model being trained using outputs from a teacher model;
evaluating, using the teacher model, a quality of the first reformulated query based on a set of criteria;
in response to determining that the quality of the first reformulated query does not satisfy the set of criteria, generating, using the teacher model and based on the user-generated query and the context, a second reformulated query that satisfies the set of criteria; and
retraining the query condenser model using the second reformulated query generated by the teacher model.

16. The non-transitory machine-readable medium of claim 15, wherein the teacher model has more parameters than the query condenser model by a threshold.

17. The non-transitory machine-readable medium of claim 15, wherein the user-generated query is received from the user device during a chat session established between the user device and a chat system, wherein the operations further comprise:
retrieving one or more utterances exchanged between the user device and the chat system during the chat session; and
deriving the context associated with the user-generated query based on the one or more utterances.

18. The non-transitory machine-readable medium of claim 15, wherein the operations further comprise:
retrieving, from a data storage, information based on the first reformulated query;
generating a prompt for a conversation model based on the user-generated query, the context, and the information; and
providing the prompt to the conversation model, wherein the conversation model is configured to generate a response to the user-generated query based on the prompt.

19. The non-transitory machine-readable medium of claim 18, wherein the operations further comprise:
obtaining the response from the conversation model; and
transmitting, to the user device, the response to the user-generated query via a chat interface.

20. The non-transitory machine-readable medium of claim 15, wherein the operations further comprise:
generating training data based on the user-generated query, the context, and the first reformulated query generated by the teacher model, wherein the retraining the query condenser model is based on the training data.
